(19) United States
(12) Patent Application Publication
(10) Pub. No.: US 2011/0278110 A1
(43) Pub. Date: Nov. 17, 2011

(54) Sealed Floating Shim for A Brake Caliper

(75) Inventor: Tim Yoko, Granger, IN (US)

(73) Assignees: Robert Bosch GmbH, Stuttgart (DE); Robert Bosch LLC, Broadview, IL (US)

(21) Appl. No.: 12/777,725

(22) Filed: May 11, 2010

(51) Int. Cl. F16D 65/00; F16D 55/22

(52) U.S. Cl. 188/73.37

(57) ABSTRACT

A disc brake system includes a disc, and a caliper housing defining a bore that faces one side of the disc. A piston is disposed in the bore for translational movement toward the disc, and a brake pad is arranged between the piston and the disc. A shim plate is arranged between the brake pad and the piston. A convolute boot is provided that has a first end portion and a second end portion. The first end portion is sealingly connected to the caliper housing. The second end portion (i) being sealingly connected to the shim plate and (ii) including an interface area sealing portion that extends between the shim plate and the piston. The interface area sealing portion is sealingly connected to the piston to define an interface area. An anti-vibration material is located in the interface area.

### TECHNICAL FIELD

The present disclosure generally relates to disc brake systems, and in particular to shims for use with brake calipers of such brake systems.

### BACKGROUND

In general, a disc brake includes a disc, or rotor, that rotates with the wheel, caliper assembly attached to a wheel carrier, or other portion of the vehicle that does not rotate with the wheel, and friction materials, such as brake pads, that are mounted to the caliper assembly. In operation, hydraulic pressure is applied to one or more pistons mounted in cylinders in the caliper which force the piston(s) into contact with the disc. Braking force is generated by friction between the disc pads as they are urged against the disc rotor by the hydraulic pressure in the caliper.

Calipers typically have either a “floating” or a “fixed” configuration. Depending on the application, a floating caliper has one or more pistons with each piston being located on one side of the caliper only. In operation, hydraulic pressure is applied to the piston(s) which for forces the inboard pad into contact with the disc. As the pressure increases, the floating caliper is moved in the opposite direction of the inboard pad which brings the outboard pad into contact with the disc. Braking force is generated by friction between the disc pads as they are urged against the disc rotor. In the fixed caliper design, one or more pistons are located on each side of the caliper on opposing sides of the disc. Hydraulic pressure is applied to the pistons located on each side of the disc which causes the pistons to force the inboard and the outboard brake pads toward each other and into contact with the disc to thereby generate the braking force.

One issue faced in the operation of disc brakes is brake noise. Brake noise is typically caused by high or low frequency vibrations that are transferred to the brake caliper or chassis components leading to audible brake moan or squeal. In addition, excessive friction generated between the piston and brake pad may lead to twisting (tapering) forces on the brake pad. Such twisting forces can cause binding of axially moving components in the caliper, such as the actuator pin that links the force applied to the brake pedal to the piston assembly in the caliper. Twisting forces may also result in uneven brake pad wear, a condition commonly referred to as taper wear. Taper wear can lead to a loss of clearance between the less worn portions of a brake pad and the brake disc which in turn may result in the less worn portions of the brake pad remaining in contact with the disc when the brake piston (brake released). Over time, excessive contact between the brake pad and disc due to taper wear can lead to uneven disc wear which in turn can lead to brake roughness or judder.

To prevent or limit brake noise in disc brakes, metal plates, referred to as shims, may be provided between the brake pad and the piston. Stainless steel clips are used to clip the shims to a backplate of the brake pad or to the head of the piston, and a layer of viscous material is provided at the interface between the plates. The viscous material provides two benefits: 1) viscous dampening between the brake pad and caliper (piston) interface for axial, tangential, and radial directions of movement of the brake pad relative to the piston; and 2) minimization of the twisting forces of the brake pads on the caliper during the application of the brakes. While effective, the viscous material in the interface is exposed to the environment. Therefore, the viscous material may escape the interface, dry up, and/or become contaminated over time which in turn degrades the performance of the shims.

### SUMMARY

In accordance with one embodiment of the present disclosure, a disc brake system is provided that includes a disc, and a caliper housing defining a bore that faces one side of the disc. A piston is disposed in the bore for translational movement toward the disc, and a brake pad is arranged between the piston and the disc. A shim plate is arranged between the brake pad and the piston. A convolute boot is provided that has a first end portion and a second end portion. The first end portion is sealingly connected to the caliper housing. The second end portion (i) is sealingly connected to the shim plate and (ii) includes an interface area sealing portion that extends between the shim plate and the piston. The interface area sealing portion is sealingly connected to the piston to define an interface area. An anti-vibration material is located in the interface area.

In accordance with another embodiment of the present disclosure, a piston assembly is provided for use in an actuation section of a disc brake. The piston assembly comprises a piston body having an end portion for arrangement in a bore of a caliper housing facing a disc. A shim plate is positioned at the end portion of the piston. A convolute boot is provided that has a first end portion and a second end portion. The first end portion is configured to be sealingly connected to the caliper housing. The second end portion (i) is sealingly connected to the shim plate and (ii) includes an interface area sealing portion that extends between the shim plate and the piston. The interface area sealing portion is sealingly connected to the piston to define an interface area. An anti-vibration material is located in the interface area.

### BRIEF DESCRIPTION OF THE FIGURES

Features of the present invention will become apparent to those of ordinary skill in the art to which this device pertains from the following description with reference to the figures, in which:

FIG. 1 is a cross-sectional view of a portion of a disc brake system including a sealed floating shim according to one embodiment of the present disclosure.

FIG. 2 is a view of the interface area of the sealed floating shim of FIG. 1 shown in more detail.

FIG. 3 is a perspective view of the shim plate of the disc brake system of FIG. 1.

### DETAILED DESCRIPTION

For the purpose of promoting an understanding of the principles of the device described herein, reference will now be made to the embodiment(s) illustrated in the figures and described in the following written specification. It is understood that no limitation to the scope of the device is thereby intended. It is further understood that the device includes any alterations and modifications to the illustrated embodiment(s) and includes further applications of the principles of the device as would normally occur to one of ordinary skill in the art to which this device pertains.

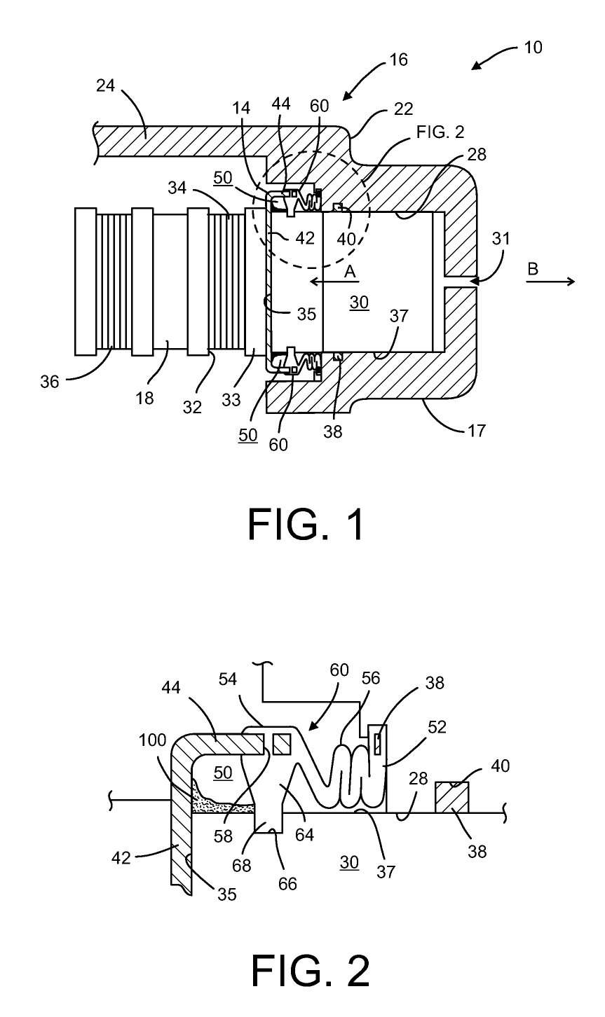

FIG. 1 depicts a portion of a disc brake system 10 in which a sealed floating shim 14 according to one embodiment of the present disclosure is incorporated. As shown, the disc brake 10 includes a disc 18, also referred to as a rotor, adapted to rotate with the wheel of a vehicle (not shown). A caliper 16 is supported in a fixed relationship with respect to the disc 18 by a support, or anchor, (not shown) fixed to a portion of the vehicle that does not rotate with the wheel (not shown). The caliper 16 of FIG. 1 may have a floating or a fixed caliper design in which one or more actuation sections are arranged on one or both sides of the disc to force a brake pad against one side of the disc. In the embodiment of FIG. 1, the caliper 16 includes a housing 22 that defines a first actuation section 17 on one side of the disc 18. The actuation section 17 of the housing defines a cylinder, or bore, 28 in which a piston 30 is arranged facing one side 32 of the disc 18 with a first friction member 34 arranged therebetween. The housing 22 of the actuation section 17 is connected to a bridge 24 that spans the disc 18. In a floating caliper design, an arm (not shown) extends from the bridge 24 on the opposite side of the disc 18 for supporting a second friction member 36 facing the opposite side of the disc 18. In a fixed caliper design, the bridge 24 is connected to a second actuation section (not shown) having a similar configuration as the actuation section 17 that supports the friction pad 36 facing the opposite side of the disc 18.

A seal ring 38 is provided in an annular recess or groove 40 in the bore. The seal ring 38 is compressed between the bottom of the groove 40 and the axially sliding piston 30 to form a fluid-tight seal. When an operator desires to apply the brakes, pressurized brake fluid is supplied to the bore 28 via an inlet 31 at the rear of the piston 30. The pressurized fluid forces the piston 30 to move in a first direction A in the cylinder and push the first friction member 34 toward the first side of the disc. In a floating caliper design, the pressurized fluid also acts on the caliper housing 22 to force the caliper housing 22 in a second direction B that is opposite the first direction A thereby moving the second friction member 36 toward the second side of the disc. In a fixed caliper design, hydraulic fluid is delivered to the actuation section on the opposite side of the disc to force the second friction member 36 toward the disc 18. In either case, the first friction member 34 and the second friction member 36 compress the disc 18 therebetween and generate a braking force based on the desired level of braking applied by the operator.

To dampen vibrations caused by frictional contact between the friction members 34, 36 and the disc 18, the disc brake 10 is provided with a sealed floating shim 14. As seen in FIG. 2, the sealed floating shim 14 comprises a shim plate 14 formed of metal, such as stainless steel, that is arranged at the front face 35 of the piston 30 between the piston 30 and a back plate 33 of the first friction member 34. The plate 14 includes a planar body portion 42 that is located adjacent to the front face 35. The plate 40 also includes an annular sidewall portion 44 that extends from the lateral edges of the planar body portion 42 toward the rear of the piston, i.e., in direction B. The planar body portion 42 of the plate has a width, or diameter, that is greater than the diameter piston 30 which results in the sidewall portion 44 of the plate being spaced apart from the piston 30 to define an interface area 50 between the sidewall portion 44 and the piston 30 that extends around the circumference of the piston.

A piston boot 60 extends between the sidewall portion 44 of the shim plate and the caliper housing 22. As best seen in FIG. 2, the piston boot 60 comprises a ring of elastomeric material, similar to a gasket, having a first annular gasket portion 52 that is attached to the caliper housing 22 in a sealing relationship, and a second annular gasket portion 54 that is attached to the sidewall portion 44 of the shim plate 14 in a sealing relationship. Extending between the first and the second annular gasket portions 52, 54 is a convolute boot section 56 that serves as a cover for enclosing the interior of the bore to thereby prevent contaminants, such as brake dust, from entering the bore. As depicted, the convolute boot section 56 is formed of a flexible, elastomeric material, such as rubber, having accordion style overlapping folds that enable the piston boot 60 to expand and retract with the movement of the piston.

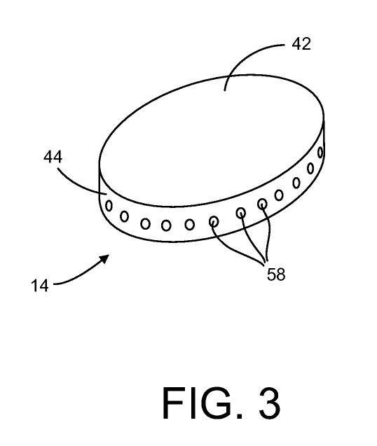

The piston boot 60 may be sealingly attached to sidewall portion 44 of the shim plate 14 and to the caliper housing 22 in any suitable manner. In the embodiment of FIGS. 1 and 2, the piston boot 60 is attached to the sidewall portion 44 using a suitable molding process. To facilitate attachment, the sidewall portion 44 of the shim plate 14 is provided with a plurality of openings 58 that extend through the sidewall portion 44, and that are spaced apart around the circumference of the sidewall portion 44 as seen in FIG. 3. The openings 58 in the sidewall 44 permit the molten elastomeric material of the boot to pass through the openings 58 during the molding process and solidify in the openings to fixedly connect the piston boot 60 to the sidewall 44 of the shim plate. The first annular gasket portion 52 of the piston boot is secured to the caliper housing 22 by a retaining device or structure, such as a metal ring or band, 38 provided as an insert in the first annular portion 52 of the piston boot. In alternative embodiments, the first annular gasket portion 52 of the boot may be formed of an elastomeric material having a durometer value that enables the first annular gasket portion 52 to be connected to the caliper housing 22 in a friction fit manner thereby eliminating the need for the retainer 38.

The second annular gasket portion 54 of the piston boot includes an inner gasket portion 64 that is interposed and sealed between the sidewall 44 of the shim plate and the side 37 of the piston 30 to define the interface area 50. The inner portion 64 of the second annular gasket portion 54 of the boot spaces the sidewall 44 apart from the side surface 37 of the piston 30 to prevent metal on metal contact between the shim plate and the piston to limit the ability of vibrations to be transferred to the piston and caliper. As best seen in FIG. 2, to form the seal, the side surface 37 of the piston 30 defines an annular groove or recess 66 in which a complementarily shaped protrusion or extension 68 of the inner portion 64 of the gasket 54 is received. The extension 68 is received in the groove 66 and sealing connected to inner surfaces of the groove 66 in a suitable manner to form a fluid-tight seal for the interface area 50 that prevents the lubricant from escaping the interface 50 and contaminating the hydraulic seal 38 for the brake fluid. In addition, using the elastomeric material of the second annular gasket portion 54 to connect the shim plate 14 to the piston 30 enables the shim plate 14 to move relative to the piston 30 and thereby absorb vibrations generated at the brake pad before the vibrations are transmitted to the caliper. Because the second annular gasket portion 54 is sealingly connected to the sidewall portion 44 of the shim plate and to the piston, the interface area traps the grease in the interface area which enables a sealed-for-life function for the shim plate 14.

To provide the shim plate 14 with vibration dampening capability, the interface area is provided with a vibration dampening material 100. Any suitable vibration dampening material may be used. In one embodiment, the material 100 comprises a viscous, lubricant material, such as silicone grease or oil. The grease acts to absorb or dampen vibrations as they transfer from the brake pads to the piston 30 or caliber housing 22. In contrast to the previously known disc brake shims, when utilizing the shim arrangement of the present disclosure, the grease used to dampen vibrations for the shim is permanently sealed into the interface area 50 to provide a sealed-for-life vibrational decoupling of the brake pads from the caliper housing 22.

It will be appreciated that various of the above-described features and functions, as well as other features and functions, or alternatives thereof, may be desirably combined into many other different systems or applications. Various presently unforeseen or unanticipated alternatives, modifications, variations or improvements therein may be subsequently made by those of ordinary skill in the art which are also intended to be encompassed by the following claims.

What is claimed is:

1. A disc brake system including:
a disc;
a caliper housing defining a bore that faces one side of the disc;
a piston disposed in the bore for translational movement toward the disc;
a brake pad arranged between the piston and the disc;
a shim plate arranged between the brake pad and the piston;
a convolute boot having a first end portion and a second end portion, the first end portion being sealingly connected to the caliper housing, and the second end portion (i) being sealingly connected to the shim plate and (ii) including an interface area sealing portion that extends between the shim plate and the piston, the interface area sealing portion being sealingly connected to the piston to define an interface area; and
an anti-vibration material located in the interface area.

2. The system of claim 1, wherein the anti-vibration material comprises a viscous material.

3. The system of claim 2, wherein the anti-vibration material comprises a grease.

4. The system of claim 1, wherein:
the shim plate includes a planar portion arranged parallel to a front face of the piston and an annular sidewall portion that extends from an edge of the planar portion in a direction toward a rear of the piston; and
the first end portion of the convolute boot is sealingly attached to the annular sidewall of the shim plate.

5. The system of claim 4, wherein the planar portion has a diameter that is greater than a diameter of the piston so that the annular sidewall is spaced apart from an interior surface of the piston to define the interface area therebetween.

6. The system of claim 5, wherein:
the piston includes an annular groove adjacent to the interface area; and
the interface area sealing portion includes an inner portion arranged between the annular sidewall of the shim plate and a side surface of the piston, and
the inner portion includes an extension that is received in the groove.

7. The system of claim 4, wherein the second end portion of the convolute boot is connected to the caliper housing by an insert ring.

8. The system of claim 4, wherein the convolute boot is formed of an elastomeric member configured to be friction fit around a portion of the caliper housing.

9. The system of claim 4, wherein the sidewall of the shim plate includes a plurality of openings through which material of the first end portion of the convolute boot extends.

10. The system of claim 1, wherein the shim plate is formed of stainless steel.

11. A piston assembly for use in an actuation section of a disc brake, the assembly comprising:
a piston body having an end portion for arrangement in a bore of a caliper housing facing a disc;
a shim plate positioned at the end portion of the piston;
a convolute boot having a first end portion and a second end portion, the first end portion configured to be sealingly connected to the caliper housing, and the second end portion (i) being sealingly connected to the shim plate and (ii) including an interface area sealing portion that extends between the shim plate and the piston, the interface area sealing portion being sealingly connected to the piston to define an interface area; and
an anti-vibration material located in the interface area.

12. The assembly of claim 10, wherein the anti-vibration material comprises a viscous material.

13. The assembly of claim 11, wherein the anti-vibration material comprises a grease.

14. The assembly of claim 10, wherein:
the shim plate includes a planar portion arranged parallel to a front face of the piston and an annular sidewall portion that extends from an edge of the planar portion in a direction toward a rear of the piston; and
the first end portion of the convolute boot is sealingly attached to the annular sidewall of the shim plate.

15. The assembly of claim 14, wherein the planar portion has a diameter that is greater than a diameter of the piston so that the annular sidewall is spaced apart from an interior surface of the piston to define the interface area therebetween.

16. The assembly of claim 15, wherein:
the piston includes an annular groove adjacent to the interface area; and
the interface area sealing portion includes an inner portion arranged between the annular sidewall of the shim plate and a side surface of the piston, and
the inner portion includes an extension that is received in the groove.

17. The assembly of claim 13, wherein the second end of the convolute boot is connected to the caliper housing by an insert ring.

18. The assembly of claim 13, wherein the convolute boot is formed of an elastomeric member configured to be friction fit around a portion of the caliper housing.

19. The assembly of claim 13, wherein the sidewall of shim plate includes a plurality of openings through which material of the first end of the convolute boot extends.
